(19) United States
(12) Patent Application Publication
(10) Pub. No.: US 2025/0015822 A1
(43) Pub. Date: Jan. 9, 2025

(54) COMMUNICATION DEVICE

(71) Applicant: Toshiba Tec Kabushiki Kaisha, Tokyo (JP)

(72) Inventor: Naohiro MATSUSHITA, Mishima Shizuoka (JP)

(73) Assignee: Toshiba Tec Kabushiki Kaisha, Tokyo (JP)

(21) Appl. No.: 18/638,331

(22) Filed: Apr. 17, 2024

(30) Foreign Application Priority Data
Jul. 3, 2023 (JP) 2023-109378

(51) Int. Cl. H04B 1/12; H02J 50/20; H04B 1/04; H04B 1/16

(52) U.S. Cl. CPC H04B 1/12; H02J 50/20; H04B 1/0475; H04B 1/1607

(57) ABSTRACT

A communication device includes a first generation unit, a common unit, a second generation unit, a suppression unit, and an adjustment unit. The common unit inputs a carrier wave generated by the first generation unit from an input terminal and outputs the carrier wave from an input and output terminal, and outputs a signal input from an output terminal. The second generation unit generates a cancelation signal by changing an amplitude and a phase of the carrier wave. The suppression unit suppresses a self-interference signal included in the signal output from the output terminal using the cancelation signal. The adjustment unit adjusts the cancelation signal generated according to the output signal from the output terminal, while inputting the carrier wave output by the first generation unit to the input terminal for a first period having a length such that the wireless tag is not activated.

### CROSS-REFERENCE TO RELATED APPLICATION

This application is based upon and claims the benefit of priority from Japanese Patent Application No. 2023-109378, filed on Jul. 3, 2023, the entire contents of which are incorporated herein by reference.

### FIELD

Embodiments described herein relate to a communication device.

### BACKGROUND

In a communication device that uses an antenna for both transmission and reception, a part of a transmission signal may be superimposed on the received signal and flow into a receiving system. The transmission signal component superimposed on the received signal becomes a self-interference signal, which may cause saturation of the receiving system and an increase in noise, leading to deterioration in communication quality.

Therefore, a technique is known in which a cancelation signal having a phase opposite to that of the self-interference signal is generated from the transmission signal, and the cancelation signal is used to cancel out the self-interference signal.

The self-interference signal varies depending on the surrounding environment. Therefore, before receiving a response signal from a wireless tag, a self-interference signal is generated by transmitting a carrier wave and the cancelation signal is adjusted such that it is possible to effectively cancel out the self-interference signal.

Incidentally, there is a type of wireless tag that operates by obtaining operating power from a carrier wave transmitted from a communication device, and transmits a response signal when the wireless tag becomes operational.

Such type of wireless tag is sometimes activated by carrier wave transmission for adjusting the cancelation signal as described above, and transmits a response signal.

Under such circumstances, it has been desired to be able to prevent the wireless tag from responding when adjusting the cancelation signal.

### DESCRIPTION OF THE DRAWINGS

FIG. 1 is a block diagram showing a main circuit configuration of a reading device according to a first embodiment;

FIG. 2 is a flowchart of a control process according to one embodiment;

FIG. 3 is a timing diagram showing a relationship between change timings of transmission power, rectified power, and response wave power;

FIG. 4 is a flowchart of a control process according to a second embodiment;

FIG. 5 is a flowchart of a control process according to a third embodiment; and

FIG. 6 is a diagram showing an example of a modification of changes in transmission power.

### DETAILED DESCRIPTION

The problem to be solved by an exemplary embodiment is to provide a communication device that can prevent a wireless tag from responding when adjusting a cancelation signal.

In general, according to an embodiment, there is a communication device that receives a response signal transmitted from a wireless tag that operates with power obtained from a received carrier wave, the device including a first generation unit, a common unit, a second generation unit, a suppression unit, and an adjustment unit. The first generation unit generates the carrier wave. The common unit inputs the carrier wave generated by the first generation unit from an input terminal and outputs the carrier wave from an input and output terminal, and outputs a signal input from the input and output terminal from an output terminal. The second generation unit generates a cancelation signal by changing an amplitude and a phase of the carrier wave generated by the first generation unit. The suppression unit suppresses a self-interference signal included in an output signal from the output terminal using the cancelation signal generated by the second generation unit. The adjustment unit adjusts the cancelation signal generated by the second generation unit according to the output signal from the output terminal, while inputting the carrier wave output by the first generation unit to the input terminal for a first period having a length such that the wireless tag is not activated.

Hereinafter, embodiments will be described with reference to the drawings. In the following, a reading device that reads data stored in a radio frequency identification (RFID) tag will be described as an example. The reading device performs wireless communication with the RFID tag when performing the above data reading, and is an example of a communication device. The RFID tag is an example of a wireless tag.

### First Embodiment

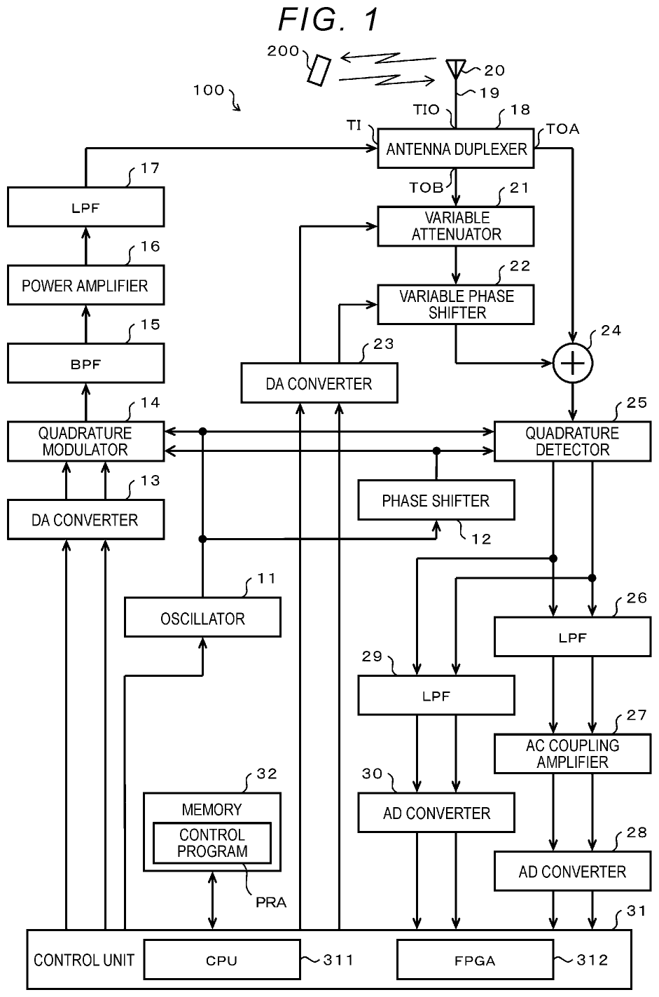

FIG. 1 is a block diagram showing a main circuit configuration of a reading device 100 according to a first embodiment.

The reading device 100 includes an oscillator 11, a phase shifter 12, a digital to analog (DA) converter 13, a quadrature modulator 14, a band-pass filter (BPF) 15, a power amplifier 16, a low-pass filter (LPF) 17, an antenna duplexer 18, a feeder line 19, an antenna 20, a variable attenuator 21, a variable phase shifter 22, a DA converter 23, a power combiner 24, a quadrature detector 25, an LPF 26, an alternating current (AC) coupling amplifier 27, an analog to digital (AD) converter 28, an LPF 29, an AD converter 30, a control unit (e.g., a controller, etc.) 31, and a memory (e.g. a storage, etc.) 32. The control unit 31 includes a CPU 311 and a field programmable gate array (FPGA) 312. Note that the antenna 20 or the feeder line 19 and the antenna 20 may not be included in the reading device 100 and any other separate device may be connectable.

The oscillator 11 generates a sine wave of a predetermined frequency as a carrier wave.

The phase shifter 12 shifts a phase of the carrier wave generated by the oscillator 11 by 90 degrees, and outputs a cosine wave as another carrier wave.

The oscillator 11 and the phase shifter 12 are examples of a first generation unit.

The DA converter 13 converts two systems of transmission baseband signals output in digital form from the CPU 311 into analog signals. Note that hereinafter, the two systems of transmission baseband signals are referred to as an I signal and a Q signal, respectively.

The quadrature modulator 14 receives the I signal and the Q signal converted into analog signals by the DA converter 13 as modulated waves. The quadrature modulator 14 inputs the carrier wave generated by the oscillator 11 and the carrier wave output from the phase shifter 12 as carrier waves of the I system and the Q system, respectively. Then, the quadrature modulator 14 obtains a transmission signal by quadrature modulation.

The BPF 15 removes low frequency components and high frequency components from the transmission signal obtained by the quadrature modulator 14 to limit the bandwidth.

The power amplifier 16 amplifies the power of the transmission signal that has passed through the BPF 15 to a level suitable for wireless transmission.

The LPF 17 removes harmonic components from the transmission signal amplified by the power amplifier 16.

Through each processing in the BPF 15, the power amplifier 16, and the LPF 17, the transmission signal becomes a signal for wireless transmission. That is, the BPF 15, the power amplifier 16, and the LPF 17 generate a transmission signal for wireless transmission.

The antenna duplexer 18 includes an input terminal TI, an input and output terminal TIO, an output terminal TOA (e.g., a first output terminal, etc.), and an output terminal TOB (e.g., a second output terminal, etc.). The transmission signal that has passed through the LPF 17 is input to the input terminal TI. The antenna duplexer 18 outputs the transmission signal input to the input terminal TI from the input and output terminal TIO and the output terminal TOB. The antenna duplexer 18 outputs the signal input to the input and output terminal TIO from the output terminal TOA. The signal output from the output terminal TOA of the antenna duplexer 18 is a signal obtained by combining a received signal generated at the antenna 20 and a self-interference signal to be described later, and the signal will be simply referred to as a received signal below. The antenna duplexer 18 is an example of a common unit.

The feeder line 19 supplies the antenna 20 with the transmission signal output from the input and output terminal TIO of the antenna duplexer 18. The feeder line 19 transmits the received signal generated at the antenna 20 to the input and output terminal TIO of the antenna duplexer 18.

The antenna 20 emits radio waves according to the transmission signal supplied by the feeder line 19. The antenna 20 generates, as a received signal, an electric signal according to the incoming radio waves.

The variable attenuator 21 attenuates the transmission signal output from the output terminal TOB of the antenna duplexer 18 with a gain corresponding to a gain setting signal supplied from the DA converter 23.

The variable phase shifter 22 changes a phase of the transmission signal after being attenuated by the variable attenuator 21 by a phase shift amount according to a phase shift amount setting signal supplied from the DA converter 23. The transmission signal after being phase-shifted by the variable phase shifter 22 is hereinafter referred to as a cancelation signal.

As such, the variable attenuator 21 and the variable phase shifter 22 implement a function as a second generation unit that generates a cancelation signal.

The DA converter 23 converts gain setting data output from the control unit 31 into an analog gain setting signal and supplies the signal to the variable attenuator 21. The DA converter converts phase shift amount setting data output from the control unit 31 into an analog phase shift amount setting signal, and supplies the signal to the variable phase shifter 22.

The power combiner 24 power-combines the received signal output from the output terminal TOA of the antenna duplexer 18 with the cancelation signal output from the variable phase shifter 22. Accordingly, the power combiner 24 reduces the self-interference signal included in the received signal. The power combiner 24 is an example of a suppression unit.

The quadrature detector 25 performs quadrature detection on the received signal output from the power combiner 24 using two carrier waves output from the oscillator 11 and the phase shifter 12, respectively. The quadrature detector 25 outputs in parallel two systems of analog received baseband signals obtained by quadrature detection.

The LPF 26 removes unnecessary frequency components other than the baseband components from each of the two systems of received baseband signals output from the quadrature detector 25.

The AC coupling amplifier 27 amplifies AC components corresponding to the response wave while cutting DC components of each of the two systems of received baseband signals that have passed through the LPF 26.

The LPF 29 removes harmonic components contained in each of the two systems of received baseband signals output from the quadrature detector 25.

The AD converter 30 digitizes each of the two systems of received baseband signals output from the LPF 29.

The memory 32 stores an information processing program that describes information processing to be executed by the CPU 311. One of the information processing programs stored in the memory 32 is a control program PRA related to control processing to be described later. The memory 32 stores various types of data necessary for the CPU 311 to execute various types of information processing (e.g., control processes, methods, etc.). The memory (e.g., a storage, etc.) 32 stores various types of data generated or acquired when the CPU 311 executes various types of information processing.

When communicating with an RFID tag 200, the CPU 311 outputs the I signal and the Q signal according to a predetermined sequence. The CPU 311 reconstructs data sent from the RFID tag 200 based on the two systems of received signals digitized by the AD converter 28. The CPU 311 executes information processing to be described later for adjusting the gain in the variable attenuator 21 and the phase shift amount in the variable phase shifter 22 based on the two systems of received baseband signals digitized by the AD converter 30.

The FPGA 312 performs preprogrammed signal processing to quickly execute various calculations associated with information processing by the CPU 311. One of the functions of the FPGA 312 is processing of calculating the amount of suppression of the self-interference signal by the cancelation signal based on the levels of the two systems of received baseband signals digitized by the AD converter 30.

Next, the operation of the reading device 100 configured as above will be described.

Prior to describing the operation, the self-interference signal will be described.

The antenna duplexer 18 is designed such that the transmission signal input to the input terminal TI is not output from the output terminal TOA. However, in an actual circuit configuration, it is difficult to completely prevent the transmission signal input to the input terminal TI from leaking out from the output terminal TOA. Therefore, a part of the transmission signal input to the input terminal TI is output as it is from the output terminal TOA. A part of the transmission signal output from the input and output terminal TIO of the antenna duplexer 18 is reflected at a feeding point of the antenna 20 and transmitted to the antenna duplexer 18 via the feeder line 19. Such a reflected signal is output from the output terminal TOA by the function of the antenna duplexer 18. As such, the signal output from the output terminal TOA of the antenna duplexer 18 includes a component of the transmission signal that leaked out without being output from the input and output terminal TIO, and a component of the transmission signal that is input as a reflected signal to the input and output terminal TIO. A signal obtained by combining the components of such transmission signals is the self-interference signal. Note that the characteristics of reflection of the transmission signal at the feeding point of the antenna 20 change depending on an environment around the antenna 20, such as a proximity situation of the RFID tag 200 and other objects to the antenna 20. Therefore, an amplitude and a phase of the signal reflected at the feeding point of the antenna 20 also vary depending on the environment around the antenna 20. Due to the influence, an amplitude and a phase of the self-interference signal also vary depending on the environment around the antenna 20.

Note that the self-interference signal is a signal derived from the transmission signal. Therefore, by combining the cancelation signal generated by changing an amplitude and a phase of a signal branched from the transmission signal with the received signal output from the output terminal TOA of the antenna duplexer 18, the self-interference signal included in the received signal can be canceled out. In the reading device 100, by combining the cancelation signal obtained by changing an amplitude and a phase with the variable attenuator 21 and the variable phase shifter 22 with the received signal output from the output terminal TOA of the antenna duplexer 18 in the power combiner 24, the self-interference signal contained in the received signal is reduced.

Note that the amplitude and the phase of the self-interference signal will fluctuate when another metal or the like is present in the vicinity of the reading device 100 and the RFID tag 200, and there is no significant change in a situation where there are no such disturbance elements. The reading device 100 basically reads the RFID tag 200 in a situation where there are no disturbance elements (hereinafter referred to as a standard situation). Even when a large fluctuation occurs in the self-interference signal due to disturbance, it is assumed that the fluctuation will be eliminated within a short period of time.

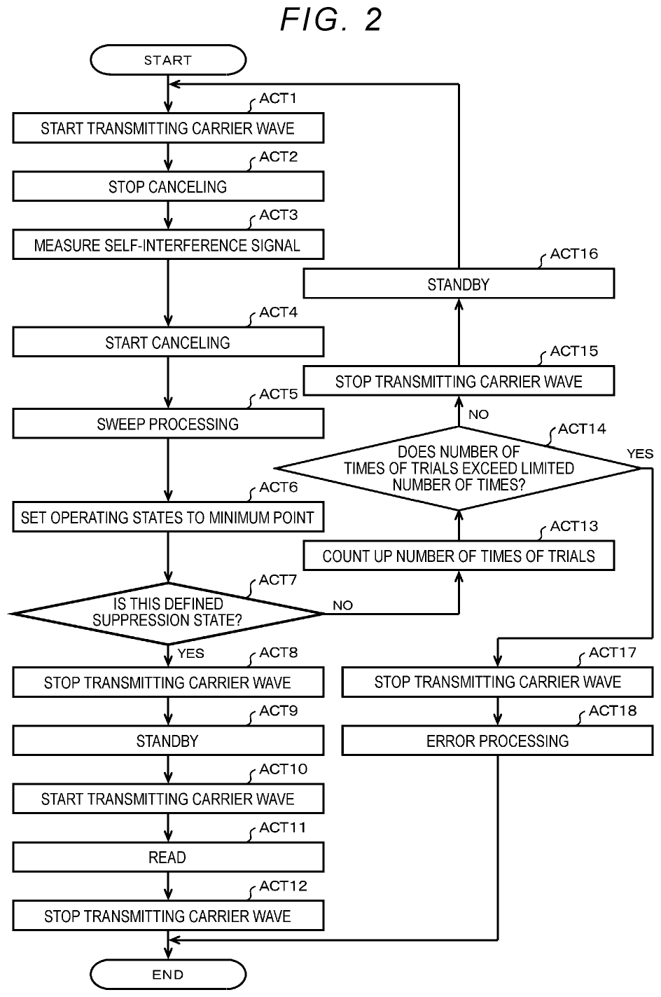

FIG. 2 is a flowchart of control processing according to the first embodiment.

When it becomes necessary to read the RFID tag 200, the CPU 311 executes the control processing shown in FIG. 2 based on the control program PRA.

In ACT 1, the CPU 311 starts transmitting the carrier wave. That is, the CPU 311 sets the quadrature modulator 14 into a state where the quadrature modulator 14 outputs the carrier waves output from the oscillator 11 and the phase shifter 12 as they are.

In ACT 2, the CPU 311 stops canceling the self-interference signal. That is, for example, the CPU 311 stops the output of the cancelation signal from the variable phase shifter 22.

In ACT 3, the CPU 311 measures the amplitude and the phase of the self-interference signal.

Here, the reading device 100 is transmitting the carrier wave, but the RFID tag 200 is not activated until the power obtained by rectifying the carrier wave (hereinafter referred to as rectified power) exceeds a certain activation power, and a response signal is not transmitted. Therefore, only the self-interference signal is input to the quadrature detector 25. Since the cancelation is stopped, the level of the output signal of the quadrature detector 25 changes according to the self-interference signal. Therefore, the FPGA 312 calculates the amplitude and the phase of the self-interference signal by performing predetermined arithmetic processing on the two systems of digital received baseband signals output from the AD converter 30. In ACT 3, the CPU 311 acquires the amplitude and the phase obtained by the FPGA 312 as described above.

In ACT 4, the CPU 311 starts canceling. That is, the CPU 311 causes the variable phase shifter 22 to start outputting the cancelation signal. The CPU 311 sets the attenuation amount of the variable attenuator 21 and the phase shift amount of the variable phase shifter 22 such that the amplitude and the phase of the cancelation signal are set to predetermined initial values. The initial values of the amplitude and the phase of the cancelation signal are determined within a predetermined sweep range. The sweep range is a range that includes the amplitude and the phase of self-interference signals that may occur under the standard situation. The sweep range may be determined as appropriate by, for example, the designer of the reading device 100.

In ACT 5, the CPU 311 sweeps the amplitude and the phase of the cancelation signal within the sweep range. That is, for example, the CPU 311 sequentially changes the attenuation amount of the variable attenuator 21 and the phase shift amount of the variable phase shifter 22 within a predetermined range depending on the sweep range. Then, the CPU 311 determines the attenuation amount and the phase shift amount when the level of the output signal of the quadrature detector 25 becomes minimum.

In ACT 6, the CPU 311 sets the operating states of the variable attenuator 21 and the variable phase shifter 22 to a minimum point. That is, the CPU 311 sets, for example, the amplitude and the phase of the cancelation signal to the attenuation amount and the phase shift amount determined in ACT 5.

In ACT 7, the CPU 311 confirms whether the defined suppression state is reached. The defined suppression state is a state where the influence of self-interference signals is sufficiently suppressed. More specifically, as an example, a defined suppression state is a state where the level of the self-interference signal component remaining in the output signal of the quadrature detector 25 (hereinafter referred to as a residual signal) has decreased to −20 dB or less compared to when there is no suppression. That is, the CPU 311 checks the amount of suppression measured by the FPGA 312, and when it is confirmed that the amount has decreased to −20 dB or less from when there is no suppression, it is determined as the defined suppression state. Note that the defined suppression state is desirably determined as a state where a minimum amount of suppression can be obtained without saturating the quadrature detector 25 due to the influence of the residual signal. The defined suppression state is determined as appropriate by, for example, the designer of the reading device 100. As the level of the self-interference signal when there is no suppression, for example, the level of the output signal of the quadrature detector 25 measured in ACT 3 can be used.

Note that, for example, when the signal levels of the two systems of received baseband signals are respectively expressed as LI and LQ, the FPGA 312 calculates the amount of suppression as the square root of the value determined as LI²+LQ². In other words, the larger the amount of suppression, the smaller the level of the residual signal, and thus the amount of suppression is calculated as the level of the residual signal.

When it is confirmed that the state is the defined suppression state, the CPU 311 determines YES in ACT 7 and proceeds to ACT 8.

In ACT 8, the CPU 311 stops transmitting the carrier wave.

Now, when the carrier wave transmitted so far reaches the RFID tag 200, the RFID tag 200 starts generating operating power as rectified power based on the carrier wave. However, a transmission period TA from when the CPU 311 starts transmitting the carrier wave in ACT 1 until when the transmission of the carrier wave is stopped in ACT 8 is set to be shorter than the time required for the rectified power in the RFID tag 200 to reach the activation voltage of the RFID tag.

The transmission period TA is mostly occupied by the period of the sweep processing in ACT 5. The length of the sweep processing period in ACT 5 changes depending on the size of the sweep range. Therefore, it is possible to adjust the length of the transmission period TA depending on the size of the sweep range. Since the sweep range is a range that includes the amplitude and the phase of the self-interference signals that may occur under the standard situation as described above, the length of the transmission period TA will be shorter than the time required for the rectified power in the RFID tag 200 to reach the activation voltage of the RFID tag.

As such, the CPU 311 executes information processing based on the control program PRA and processes ACT 1 to ACT 8, and accordingly, the computer with the CPU 311 as a core functions as an adjustment unit.

In ACT 9, the CPU 311 waits for a predetermined standby period TB. The length of the standby period TB is appropriately determined by, for example, the designer of the reading device 100, as the time until the rectified power that has increased in the RFID tag 200 during the transmission period TA is sufficiently reduced.

In ACT 10, the CPU 311 starts transmitting the carrier wave. The transmission of the carrier wave continues even after reaching the time required for the rectified power to reach the activation voltage at the RFID tag 200.

In ACT 11, the CPU 311 reads the RFID tag 200. That is, the CPU 311 performs processing for the RFID tag 200 to activate and transmit a response signal, and receives the response signal. The processing for receiving the response signal may be similar to that performed in another existing reading device. After the CPU 311 completes reading the response signal, the CPU 311 proceeds to ACT 12.

In ACT 12, the CPU 311 stops transmitting the carrier wave. The CPU 311 then ends the current control processing.

Now, when the reading device 100 is in a standard situation, the amplitude and the phase of the self-interference signal are likely to be within the sweep range. Therefore, the CPU 311 determines YES in ACT 7 and executes ACT 8 to ACT 12. However, when it is not the standard situation due to reasons such as proximity of metal objects, the CPU 311 may not be able to determine the minimum point at which the defined suppression state can be achieved in the sweep processing in ACT 5. Then, the CPU 311 determines NO in ACT 7, and proceeds to ACT 13.

In ACT 13, the CPU 311 counts up the number of times of trials.

In ACT 14, the CPU 311 confirms whether the number of times of trials exceeds limited number of times. The CPU 311 determines NO when the number of times of trials counted up in ACT 13 does not exceed the predetermined limited number of times, and proceeds to ACT 15. Note that the limited number of times is determined as appropriate by, for example, the designer of the reading device 100.

In ACT 15, the CPU 311 stops transmitting the carrier wave.

In ACT 16, the CPU 311 waits for the standby period TB. Thereafter, the CPU 311 repeats ACT 1 and subsequent steps same as described above.

As such, the CPU 311 repeats ACT 1 to ACT 7 and ACT 13 to ACT 16 until the reading device 100 returns to the standard situation and can determine the minimum point at which the defined suppression state is reached by sweeping the amplitude and the phase within a predetermined sweep range. Here, regarding the transmission of the carrier wave, since the transmission period TA of the carrier wave is repeated with the standby period TB interposed therebetween, the rectified power in the RFID tag 200 does not reach the activation voltage.

The CPU 311 executes ACT 8 to ACT 12 when the reading device 100 returns to the standard situation and the minimum point at which the defined suppression state is reached is determined by sweeping the amplitude and the phase within the predetermined sweep range.

As such, the CPU 311 executes information processing based on the control program PRA and processes ACT 3, ACT 21, ACT 4, and ACT 6 to ACT 8, and accordingly, the computer with the CPU 311 as a core functions as an adjustment unit.

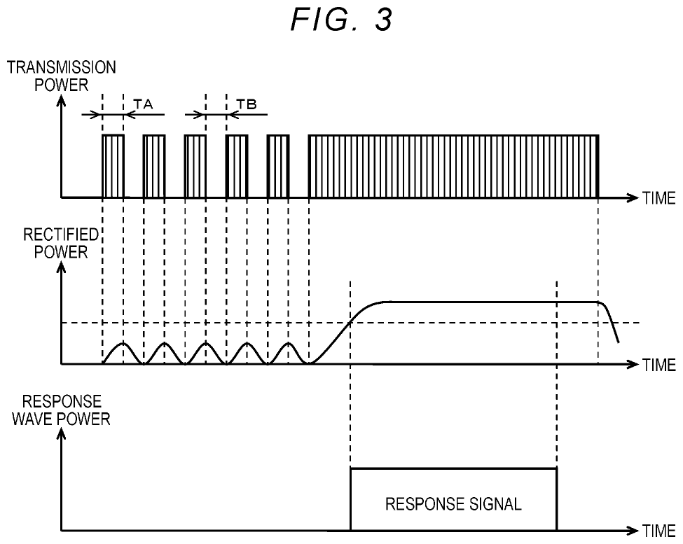

FIG. 3 is a timing diagram showing a relationship between change timings of transmission power, rectified power, and response wave power.

FIG. 3 shows an example of a case where the minimum point at which the defined suppression state is achieved can be determined when ACT 1 to ACT 6 in FIG. 2 are executed for the fifth time.

Now, when the number of times of trials counted in ACT 13 for ACT 1 to ACT 6 exceeds the limited number of times, the CPU 311 determines YES in ACT 14, and proceeds to ACT 17.

In ACT 17, the CPU 311 stops transmitting the carrier wave.

In ACT 18, the CPU 311 executes error processing. For example, as error processing, the CPU 311 performs processing for displaying an error to inform the operator that the environment is not appropriate for reading. The CPU 311 may perform other processing, such as playing a voice message, as error processing. The CPU 311 may execute multiple types of processing as error processing. After completing the error processing, the CPU 311 ends the current control processing.

### Second Embodiment

Since the main circuit configuration of the reading device according to a second embodiment is the same as that of the first embodiment, illustration thereof will be omitted and will be described below as the reading device 100.

The reading device 100 according to the second embodiment differs from the reading device 100 according to the first embodiment in the content of the control processing represented by the control program PRA.

Thus, the contents of the operation of the reading device 100 according to the second embodiment differs from that of the control processing of the reading device 100 according to the first embodiment.

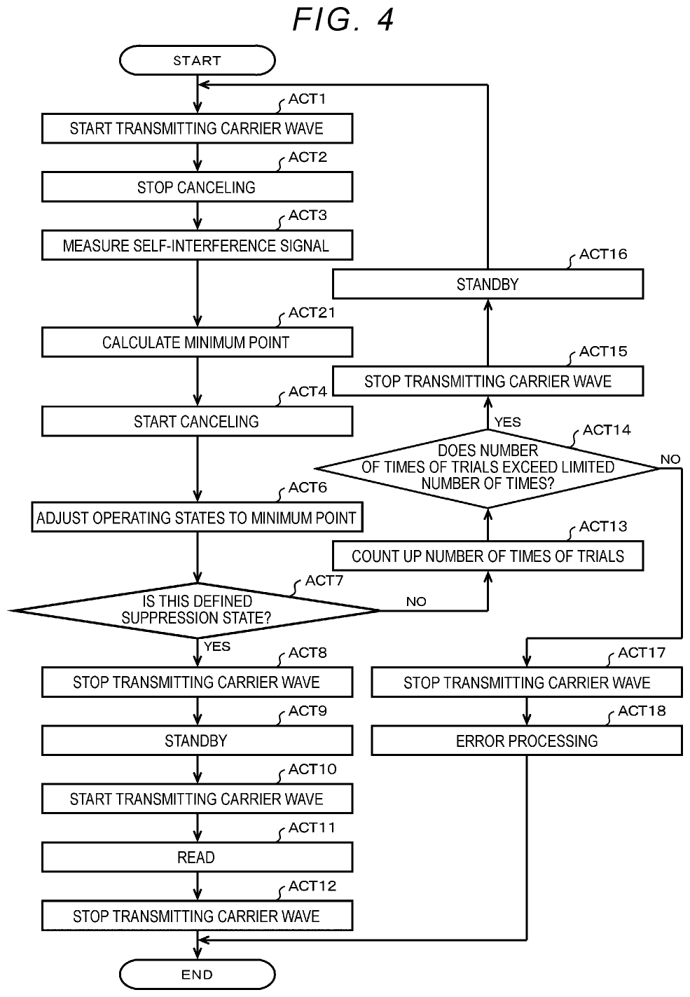

FIG. 4 is a flowchart of the control processing according to the second embodiment.

Note that in FIG. 4, the same processing as shown in FIG. 2 are denoted by the same reference numerals.

The CPU 311 executes ACT 1 to ACT 3 in the same manner as in the first embodiment.

In ACT 21, the CPU 311 calculates the amplitude and the phase that are the minimum point within a range similar to the sweep range in the first embodiment.

Thereafter, the CPU 311 starts canceling in ACT 4, and then proceeds to ACT 6 without performing ACT 5.

Then, in ACT 6, the CPU 311 sets the operating states of the variable attenuator 21 and the variable phase shifter 22 to the minimum point calculated in ACT 21.

The control processing in the second embodiment is similar to the first embodiment except for the above points.

### Third Embodiment

Since the main circuit configuration of the reading device according to a third embodiment is the same as that of the first embodiment, illustration thereof will be omitted and will be described below as the reading device 100.

The reading device 100 according to the third embodiment differs from the reading device 100 according to the first embodiment in the content of the control processing represented by the control program PRA.

Thus, the contents of the operation of the reading device 100 according to the third embodiment differs from that of the control processing of the reading device 100 according to the first embodiment.

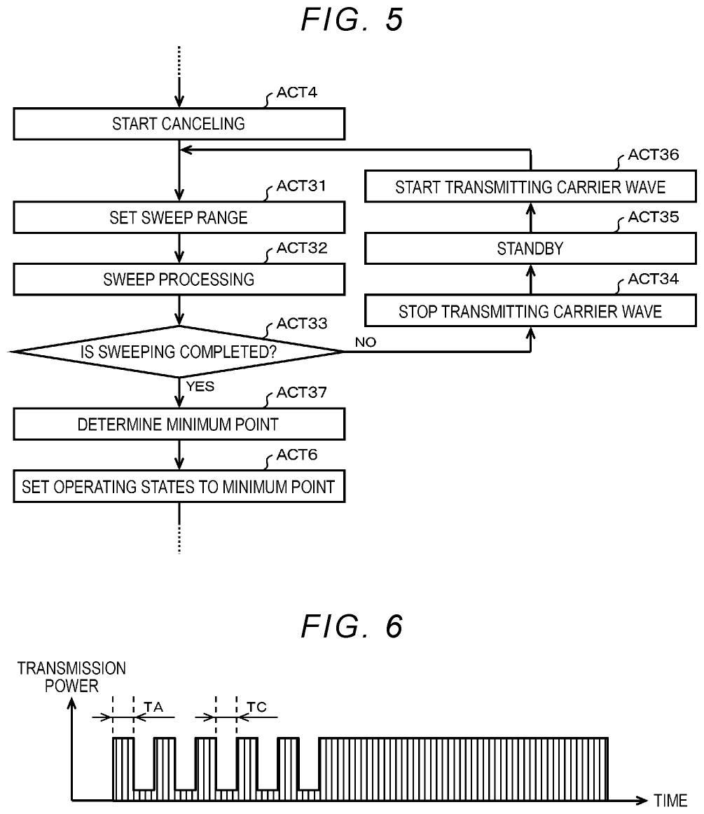

FIG. 5 is a flowchart of the control processing according to the third embodiment.

Note that in FIG. 5, the same processing as shown in FIG. 2 are denoted by the same reference numerals. In FIG. 5, many of the same processing as shown in FIG. 2 are omitted.

The CPU 311 executes ACT 1 to ACT 4 in the same manner as in the first embodiment. After completing ACT 4, the CPU 311 proceeds to ACT 31.

In ACT 31, the CPU 311 sets the sweep range. Here, in the third embodiment, it is assumed that the sweep is performed sequentially in a range including the amplitude and the phase of the self-interference signals that may occur in a standard situation, that is, a plurality of sweep ranges determined by dividing the sweep range in the first and second embodiments into a plurality of sweep ranges. Therefore, the CPU 311 in the present embodiment sets one of the plurality of sweep ranges set in advance as described above as the sweep range for the sweep processing to be performed from now on.

However, the range covered by the plurality of sweep ranges in the third embodiment may be different in size from the sweep ranges in the first and second embodiments. For example, it is assumed that the range covered by the plurality of sweep ranges in the third embodiment is set to be larger than the sweep ranges in the first and second embodiments. Note that the range covered by the plurality of sweep ranges and the number of divisions thereof in the third embodiment may be determined as appropriate by, for example, the designer of the reading device 100.

In ACT 32, the CPU 311 performs the sweep processing targeting the sweep range set in ACT 31. The sweep processing may be similar to the sweep processing in ACT 5 in FIG. 2, although the sweep range is different.

In ACT 33, the CPU 311 confirms whether the sweep processing for each of the plurality of sweep ranges is completed. The CPU 311 determines NO when there is a sweep range that has not yet undergone sweep processing among the plurality of sweep ranges, and proceeds to ACT 34.

In ACT 34, the CPU 311 stops transmitting the carrier wave.

In ACT 35, the CPU 311 waits for the standby period TB.

In ACT 36, the CPU 311 starts transmitting the carrier wave. Thereafter, the CPU 311 repeats ACT 31 and subsequent steps. Note that when the CPU 311 returns from ACT 36 to ACT 31, in ACT 31, while repeating ACT 31 to ACT 36, a sweep range different from the sweep range already selected in ACT 31 is set as the target of the next sweep processing. Thereby, the CPU 311 sequentially performs the sweep processing targeting each of the plurality of sweep ranges by repeating ACT 31 to ACT 36.

When the sweep processing for each of the plurality of sweep ranges is completed, the CPU 311 determines YES in ACT 33, and proceeds to ACT 37.

In ACT 37, the CPU 311 determines the minimum point among the minimum points determined in each of the plurality of sweep processing. Thereafter, the CPU 311 executes the processing of ACT 6 and the subsequent steps in the same manner as in the first embodiment.

As such, the CPU 311 executes information processing based on the control program PRA and processes ACT 3, ACT 31 to ACT 37, and ACT 6 to ACT 8, and accordingly, the computer with the CPU 311 as a core functions as an adjustment unit.

As described above, in the reading device 100 of each embodiment, the transmission period TA of the carrier wave for transmitting the cancelation signal is kept at a length such that the rectified power does not reach the activation voltage in the RFID tag 200. Thereby, according to the reading device 100, it is possible to prevent the wireless tag from responding when adjusting the cancelation signal.

When the reading device 100 transmits the carrier wave signal multiple times, the standby period TB is provided such that the rectified power does not reach the activation voltage in the RFID tag 200 due to the multiple carrier wave transmissions. Thereby, according to the reading device 100, even when carrier wave transmission is required multiple times, it is possible to prevent the wireless tag from responding when adjusting the cancelation signal.

The reading device 100 of the third embodiment performs sweep processing regarding different sweep ranges in a plurality of carrier wave transmission periods TA with the standby period TB interposed therebetween. Therefore, it is possible to determine the minimum point by performing sweeping over a wider range than the sweep range that can be realized in one transmission period TA while the rectified power does not reach the activation voltage in the RFID tag 200.

The embodiment can be modified in various manners as follows.

In the first, second, and third embodiments, as shown in FIG. 6, instead of the standby period TB, a low output period TC may be provided in which the output is sufficiently reduced while carrier wave transmission continues.

Each function implemented by the CPU 311 through information processing can be partially or entirely implemented by hardware such as a logic circuit that executes information processing without being based on a program. Each of the above functions can also be implemented by combining software control with the above-described hardware such as logic circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device that receives a response signal transmitted from a wireless tag, the wireless tag operates with power obtained from a received carrier wave, the device comprising:
a first generation unit configured to generate the carrier wave;
a common unit configured to:
input, by an input terminal, the carrier wave,
output, by an input and output terminal, the carrier wave, and
output, by an output terminal, a signal input to the input and output terminal;
a second generation unit configured to generate a cancelation signal by changing an amplitude and a phase of the carrier wave;
a suppression unit configured to suppress a self-interference signal included in the signal output from the output terminal by combining the signal output from the output terminal and the cancelation signal; and
an adjustment unit configured to adjust the cancelation signal according to the signal output from the output terminal, while inputting the carrier wave output by the first generation unit to the input terminal of the common unit for a first period having a length such that the wireless tag is not activated.

2. The device according to claim 1, wherein
when the adjustment unit fails to fully adjust the cancelation signal in the first period, the adjustment unit is configured to stop inputting the carrier wave to the input terminal in a second period having a predetermined length, and then, the adjustment unit adjusts the cancelation signal generated according to the signal output from the output terminal, while again inputting the carrier wave output by the first generation unit to the input terminal in the first period.

3. The device of claim 2, wherein the second period is a time until a power of the wireless tag is reduced to be less than or equal to a predetermined threshold.

4. The device according to claim 1, wherein
when the adjustment unit fails to fully adjust the cancelation signal in the first period, the adjustment unit is configured to lower an input level of the carrier wave to the input terminal in a second period having a predetermined length, and then, the adjustment unit adjusts the cancelation signal according to signal output from the output terminal, while again inputting the carrier wave output by the first generation unit to the input terminal in the first period.

5. The device according to claim 1, wherein the adjustment unit is configured to cause the second generation unit to output the cancelation signal, measure the amplitude and the phase of the self-interference signal, and set an initial amplitude value and an initial phase value of the cancelation signal within a predetermined sweep range.

6. The device according to claim 5, wherein the adjustment unit is configured to perform a sweep process of the amplitude and the phase of the cancelation signal within the predetermined sweep range, and wherein the sweep process defines the first period.

7. The device according to claim 6, wherein the adjustment unit is configured to sequentially change an attenuation amount of the second generation unit within a predetermined range based on the predetermined sweep range.

8. The device according to claim 6, wherein the adjustment unit determines the attenuation amount when a level of the output signal becomes a minimum level.

9. The device according to claim 1, wherein the adjustment unit is configured to determine if a defined suppression state is reached, the defined suppression state being a state where the self-interference signal is sufficiently suppressed.

10. The device according to claim 9, wherein the self-interference signal is sufficiently suppressed when the output signal has decreased to −20 decibels or less compared to when there is no suppression.

11. The device according to claim 9, wherein in response to the defined suppression state not being reached, the adjustment unit is configured to count a number of trials of adjusting the cancelation signal.

12. The device according to claim 11, wherein when the number of trials exceeds a limit, the adjustment unit is configured to stop inputting the carrier wave and indicate an error.

13. The device according to claim 12, wherein the adjustment unit is configured to play a voice message to indicate the error.

14. A communication device that receives a response signal transmitted from a wireless tag, the wireless tag operates with power obtained from a received carrier wave, the device comprising:
a first generation unit configured to generate the carrier wave;
a common unit configured to:
input, by an input terminal, the carrier wave,
output, by an input and output terminal, the carrier wave, and
output, by an output terminal, a signal input to the input and output terminal;
a second generation unit configured to generate a cancelation signal by changing an amplitude and a phase of the carrier wave;
a suppression unit configured to suppress a self-interference signal included in the signal output from the output terminal by combining the signal output from the output terminal and the cancelation signal; and
an adjustment unit configured to form a state where the carrier wave is input to the input terminal for a first period having a length such that the wireless tag is not activated a plurality of times, while interposing a state where the carrier wave is not input to the input terminal for a second period having a predetermined length, and adjust the cancelation signal according to the signal output from the output terminal for the first period for the plurality of times.

15. The device of claim 14, wherein the adjustment unit is further configured to calculate the amplitude and the phase of the carrier wave at a minimum point within a predetermined sweep range.

16. The device of claim 15, wherein the adjustment unit is further configured to set an operating state of the second generation unit to the minimum point.

17. A communication device that receives a response signal transmitted from a wireless tag, the wireless tag operates with power obtained from a received carrier wave, the device comprising:
a first generation unit configured to generate the carrier wave;
a common unit configured to:
input, by an input terminal, the carrier wave,
output, by an input and output terminal, the carrier wave, and
output, by an output terminal, a signal input to the input and output terminal;
a second generation unit configured to generate a cancelation signal by changing an amplitude and a phase of the carrier wave;
a suppression unit configured to suppress a self-interference signal included in the signal output signal from the output terminal by combining the signal output from the output terminal and the cancelation signal; and
an adjustment unit configured to form a state where the carrier wave output by the first generation unit is input to the input terminal for a first period having a length such that the wireless tag is not activated a plurality of times, while interposing a state where an input level of the carrier wave to the input terminal is lowered for a second period having a predetermined length, and adjust the cancelation signal according to the signal output from the output terminal for the first period for the plurality of times.

18. The device of claim 17, wherein the adjustment unit is configured to set a sweep range, the sweep range determined by dividing a predetermined sweep range into a plurality of sweep ranges and selecting one of the plurality of sweep ranges.

19. The device according to claim 18, wherein the adjustment unit is configured to perform a sweep process of selected sweep range, and wherein the sweep process defines the first period.

20. The device of claim 17, wherein the adjustment unit is configured to determine a minimum point for each of the plurality of sweep ranges, and determine a minimum of the minimum points, and set an operating state of the second generation unit to the minimum.
